(19) United States
(12) Patent Application Publication
(10) Pub. No.: US 2026/0290221 A1
(43) Pub. Date: Sep. 24, 2026

(54) TIMING CONTROLLER, DISPLAY DEVICE INCLUDING THE SAME AND OPERATIONAL METHOD THEREOF

(71) Applicant: LX SEMICON CO., LTD., Daejeon (KR)

(72) Inventor: Jae Young HEO, Daejeon (KR)

(73) Assignee: LX SEMICON CO., LTD., Daejeon (KR)

(21) Appl. No.: 19/145,060

(22) PCT Filed: Dec. 29, 2023
(86) PCT No.: PCT/KR2023/022046

§ 371 Date: Jun. 9, 2026

(30) Foreign Application Priority Data
Jan. 2, 2023 (KR) 10-2023-0000382

(51) Int. Cl. G09G 3/20

(52) U.S. Cl. CPC G09G 3/2096; G09G 2310/0297; G09G 2330/021; G09G 2360/12

(57) ABSTRACT

A timing controller includes a memory controller configured to receive image data through an input port and generate a memory control signal; a first memory on which a write/read operation is performed on the image data; a first data processor configured to perform a read operation on the data in the first memory, map it, and control packets; and a multiplexer, wherein the multiplexer is configured to control the first memory to be in sync with a second data processor configured to transmit a differential signal through an output port based on the memory control signal.

### CROSS-REFERENCE TO RELATED APPLICATIONS

This application is a national phase entry of PCT International Application No. PCT/KR2023/022046 filed on Dec. 29, 2023, which claims the priority of Korean Application No. 10-2023-0000382 filed on Jan. 2, 2023, which are hereby incorporated by reference in their entirety.

### BACKGROUND

### Field of the Disclosure

The present disclosure relates to a timing controller, a display device including the same, and an operational method thereof.

### Description of the Background

A plurality of data lines and gate lines are disposed on the display panel, and pixels may be defined in accordance with the intersection of the data lines and the gate lines.

Each pixel includes a transistor, which is turned on by a gate signal supplied to the gate line.

When the transistor is turned on, the data line is connected to the pixel, and the data voltage is supplied to the pixel. And a brightness of the pixel changes depending on a size of the data voltage, and the image is displayed on the display panel accordingly.

As the display panel becomes larger, different picture quality degradation may occur at each panel location where multiple gate driving integrated chips (ICs) are responsible. Therefore, an existing method of applying the image quality improvement function to multiple gate driving ICs at once does not sufficiently improve image quality degradation that occurs differently depending on the panel location.

### SUMMARY

To solve the above problems, the present disclosure is to provide a timing controller employing a structure that may reduce memory usage or reduce a memory size.

The present disclosure is also to provide a display device including the above-described timing controller and a method of operating the same.

The problems to be achieved by the present disclosure are not limited to the technical problems mentioned above, and other problems not mentioned are clearly understood by those skilled in the art from the description below.

A timing controller may include a memory controller configured to receive image data through an input port and generate a memory control signal; a first memory on which a write/read operation is performed on the image data; a first data processor configured to perform a read operation on the data in the first memory, map it, and control packets; and a multiplexer, wherein the multiplexer is configured to control the first memory to be in sync with a second data processor configured to transmit a differential signal through an output port based on the memory control signal.

A timing controller may include a memory controller configured to receive and transmit image data through an input port and generate a memory control signal; a data merger configured to receive image data from the memory control and merge them; a first memory on which a write/read operation is performed on the merged image data; a first data processor configured to perform a read operation on the data in the first memory and map it; a multiplexer configured to output the mapped data in order; and a second memory configured to output data output from the multiplexer in sync with a second data processor that transmits a differential signal to a source driver through a port.

A timing controller may include a memory controller configured to receive image data through an input port and generate a memory control signal; a data merger configured to receive image data from the memory controller and merge them; a first memory on which a write/read operation is performed on the merged image data; a first processor configured to perform a read operation on the data in the first memory, map it, and control packets; and a multiplexer, wherein the multiplexer is configured to control the first memory to be in sync with a second processor that transmits a differential signal through an output port based on the memory control signal.

According to at least one of the various aspects of the present disclosure, there are technical effects as follows:

First, there is a technical effect of reducing a memory size compared to data throughput.

Second, there is a technical effect of reducing a chip size by reducing the memory size.

Third, there is a technical effect of reducing a power consumption of a display device.

The technical effects that may be obtained from the present disclosure are not limited to the technical effects mentioned above, and other technical effects not mentioned above will be clearly understood by those skilled in the art from the description below.

### BRIEF DESCRIPTION OF THE DRAWINGS

FIG. 1 is a configuration diagram of a display device according to an aspect of the present disclosure.

FIG. 2 is a diagram illustrating the data flow for screen output in the display device.

FIG. 3 is a diagram illustrating an operation of a timing controller according to an aspect of the present disclosure.

FIG. 4 is a diagram illustrating an operation of the timing controller according to another aspect of the present disclosure.

FIG. 5 is a diagram illustrating an operation of the timing controller according to another aspect of the present disclosure.

FIG. 6 illustrates a diagram to explain an operation of the timing controller according to another aspect of the present disclosure.

FIG. 7 is a flowchart illustrating the operation of the timing controller according to an aspect of the present disclosure.

FIGS. 8 to 10 are diagrams to explain a method of reducing the memory size of FIG. 5.

FIGS. 11A-11B and 12A-12B illustrate waveform diagrams of the timing controller related to the present disclosure.

FIGS. 13A-13B are diagrams illustrating a port swap related to the present disclosure.

### DETAILED DESCRIPTION

To fully understand the present disclosure, its operational advantages achieved by the present disclosure, reference should be made to the accompanying drawings explaining exemplary aspects of the present disclosure and the content described in the accompanying drawings.

Hereinafter, the present disclosure will be described in detail by explaining various aspects of the present disclosure referring to the attached drawings.

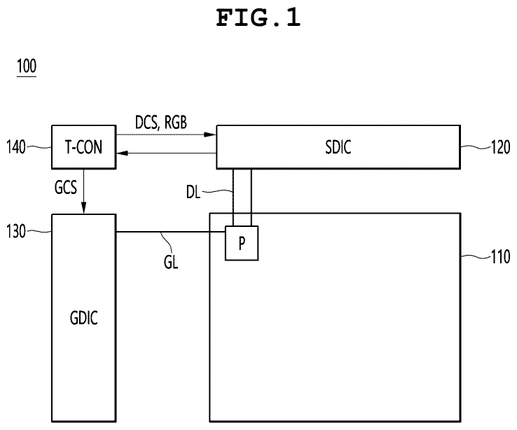

FIG. 1 is a configuration diagram of a display device 100 according to an aspect of the present disclosure.

Referring to FIG. 1, the display device 100 may include a panel 110, a source driver 120, a gate driver 130, a timing controller (TCON) 140, etc.

A plurality of data lines (DL: Data Line) and a plurality of gate lines (GL: Gate Line) may be arranged in the panel 110, and a plurality of pixels (P: pixels) may be arranged.

The gate driver 130 may supply a scan signal of a turn-on voltage or turn-off voltage to the gate line (GL). When a scan signal of a turn-on voltage is supplied to the pixel (P), the pixel (P) is connected to the data line (DL). When a scan signal of a turn-off voltage is supplied to the pixel (P), a connection between the pixel (P) and data line (DL) is disconnected.

The source driver 120 supplies a data voltage to the data line (DL). The data voltage supplied to the data line (DL) is transmitted to the pixel (P) connected to the data line (DL) according to the scan signal.

The source driver 120 may be referred to as a data driving circuit or a source driver integrated circuit (SDIC).

The source driver 120 may sense characteristic values formed in each pixel P-for example, voltage, current, etc. The source driver 120 may be connected to each pixel (P) by a scan line, or may be connected to each pixel (P) by a separate sensing line. At this time, the sensing signal may be generated by the gate driver 130.

The timing controller 140 may supply various control signals to the gate driver 130 and source driver 120. The timing controller 140 may generate a gate control signal (GCS) to start scanning according to a timing implemented in each frame and transmit the GCS to the gate driver 130.

Additionally, the timing controller 140 may output image data (RGB) to the source driver 120. In this case, the image data (RGB) is converted from image data input from an external to be fitted a data signal format used in the source driver 120.

Additionally, the timing controller 140 may transmit a data control signal (DCS) that controls the source driver 120 to supply a data voltage to each pixel (P) according to each timing.

The timing controller 140 may compensate and transmit image data (RGB) according to the characteristics of the pixel (P).

The timing controller 140 may control a Power Management IC (PMIC) to supply a voltage to the panel 110.

The panel 110 may be an organic light emitting display panel, but is not limited thereto. For example, the pixels (P) disposed on the panel 110 may include an organic light emitting diode (OLED) and one or more transistors.

The characteristics of the organic light emitting diode (OLED) and transistor included in each pixel (P) may change depending on time or surrounding environment, and the source driver 120 may sense and transmit the characteristics of them included in each pixel (P) to the timing controller 140.

The source driver 120 may be included in one integrated circuit. Additionally, the source driver 120 and the timing controller 140 are included in one integrated circuit and may be referred to as an integrated IC.

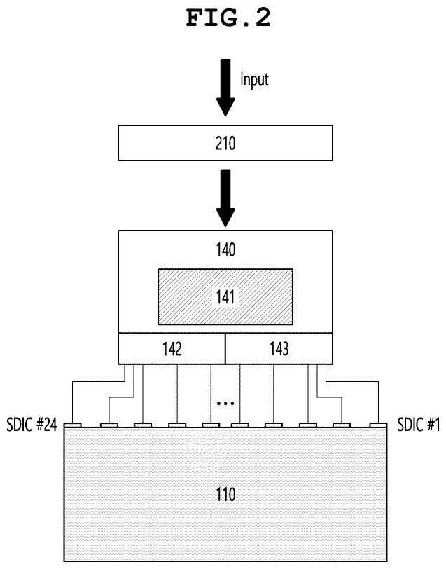

FIG. 2 is a diagram illustrating a data flow for screen output in the display device 100.

As shown in FIG. 2, to output the screen, data may be transmitted in order such as a system (or a host) (SoC), the timing controller 140, the source driver (SDIC #1 to SDID #24) 120, and the panel 110.

In this case, the timing controller 140 may include a first processor (TX LINK) 141, a second processor (TX PHY) 142 and 143, etc.

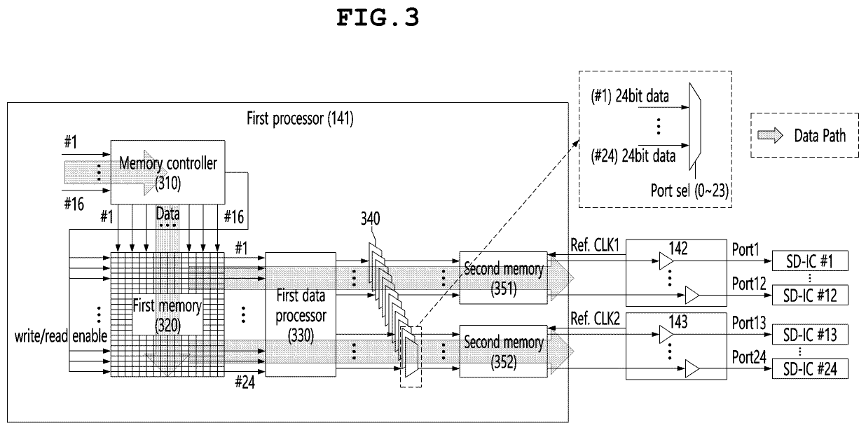

FIG. 3 is a diagram illustrating the operation of the timing controller 140 according to an aspect of the present disclosure.

In FIG. 3, the timing controller 140 may include the first processor (TX LINK) 141 that obtains and processes image data input through input ports (port1 to port16). The timing controller 140 may include second processors (TX PHY) 142 and 143 that transmit the data to the source driver 120.

The second processors (TX PHY) 142 and 143 may transmit data through output ports (port1 to port24) to the source driver 120. In this case, the first data processor (TX LINK) 141 may be needed to be synchronized with the second data processors 142 and 143.

The first processor (TX LINK) 141 may control the input image data to be a pixel mapping with a consideration that a structure of the panel 110, the source driver 120, and the second data processor (TX PHY) 142 and 143.

The memory controller 310 may obtain image data through an input port, preprocess the obtained image data before inputting it to the first memory 320, and generate a first memory write/read enable signal (Write/Read enable signal).

The first memory 320 may be used to output image data according to the channel of the source driver 120. At this time, the data storage amount of the first memory 320 may require memory equal to the resolution (Horizontal)*2 amount. That is, the number of the memory may be determined by the number of input ports x the number of output ports. The first memory 320 may be a port memory.

The first data processor 330 may map pixel data according to the panel structure and perform packet control of the source driver 120. At this time, the first data processor 330 may be referred to as a pixel mapping & packet inserter (i.e., Pixel Mapping+Packet Insertion).

The multiplexer (Mux or MUX) 340 may control a proper operation in accordance with the panel structure and the order of the source driver 120. At this time, the multiplexer 340 may correspond to, for example, a port swap.

The second memories 351 and 352 may perform a role of synchronization with the second processor (or named second data processors) 142 and 143 during the port swap. The second memories 351 and 352 may be buffer memories.

The second processors 142 and 143 may convert digital data into analog data and transmit a differential signal to the source driver 120.

Meanwhile, the source driver 120 previously described in FIG. 1 may drive the panel 110 by charging or discharging a specific voltage corresponding to the input data on the panel data line (DL).

As the display device 100 becomes larger and higher-resolution, the amount of data to be processed by the timing controller 140 increases explosively, so more memories are required accordingly.

Meanwhile, since a plurality of second processors (TX PHY) 142 and 143 are also required according to this trend, a buffer memory (not shown) for synchronization with the second processor (TX PHY) is required.

In this way, the memory usage of the first processor (TX LINK) 141 included in the timing controller 140 for pixel mapping of the panel 110 increases with increasing resolution. There is no choice but to do so. However, the increase of memory usage causes heat generation and increase of power consumption of the display device 100.

Accordingly, a method of reducing power consumption of the display device 100 will be explained. To reduce such power consumption, a method of reducing memory use or reducing the size of the memory are disclosed specifically. Meanwhile, the memory includes, for example, the memory and the buffer memory of the timing controller 140, but is not limited thereto.

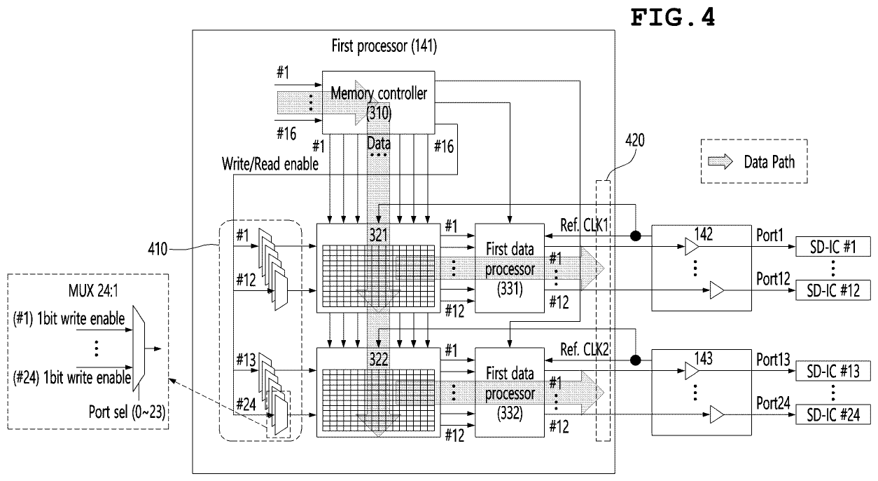

Hereinafter, in describing the timing controller 140 of FIGS. 4 to 6, descriptions of parts overlapping with those of FIG. 3 described above will be cited, and overlapping descriptions will be omitted.

However, even if the configuration is the same, if the functions are different, they will be explained separately.

FIG. 4 illustrates a diagram to explain the operation of the timing controller 140 according to another aspect of the present disclosure.

In FIG. 4, for example, a method of synchronizing with the second processors 142 and 143 without using the second memories 351 and 352 of FIG. 3 described above will be described.

Referring to FIG. 4, the timing controller 140 according to an aspect of the present disclosure may include a memory controller 310 that receives image data through an input port and generates a memory control signal, a first memories 321 and 322 that receive image data from the memory controller 310, first data processors 331 and 332 that map data and control packets, and a multiplexer 410.

At this time, the multiplexer 410 may control the first memories 321 and 322 to be in sync with the second processors 142 and 143 that transmit differential signals through the output port based on the memory control signal received from the memory controller 310.

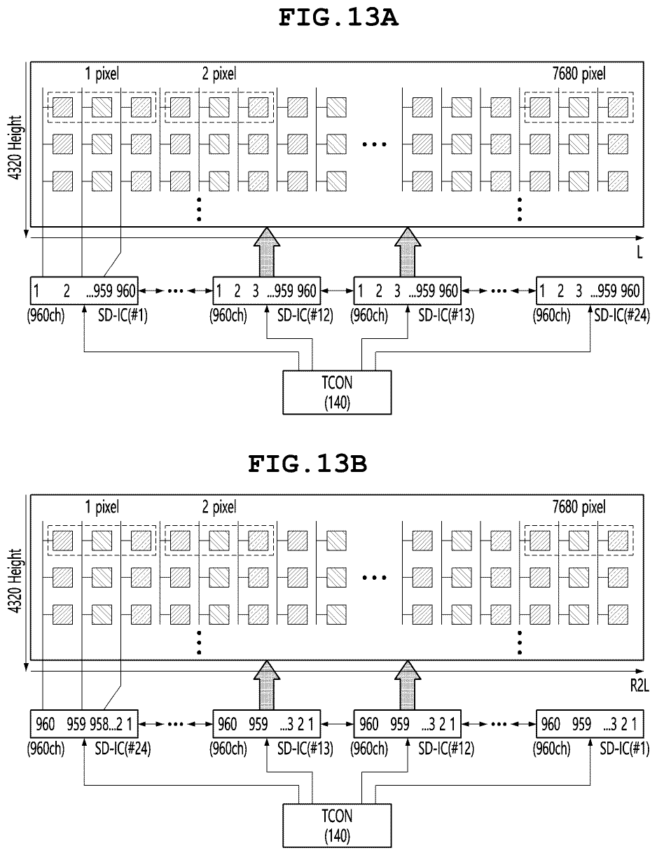

Meanwhile, in FIG. 13A, the screen output direction is from left to right and the port output order is from port 1 to port 24. On the other hand, in FIG. 13B, the screen output direction is from right to left and the port output order is from port 24 to port 1.

In this way, further referring to FIGS. 13A-13B, the first processor 141 may be synchronized with the second processors 142 and 143 by processing a swap in advance when writing the port swap location processed after reading the first memories 321 and 322 to the first memories 321 and 322. Therefore, there is no need to use a separate second memory (see 420) in the first processor 141 according to an aspect of the present disclosure. In other words, since the first memories 321 and 322 included in the first processor 141 may perform the functions of the second memories 351 and 352 according to change of the port swap location, no further memories are needed.

Meanwhile, the first processor 141 may process data for each source driver (SD-IC #1-12, SD-IC #13-24) 120 by dividing the memory areas 321 and 322. Accordingly, if the first processor 141 may process data by pre-determining the memory writing area, the output port swap function may be replaced without using the second memories 351 and 352.

Regarding this, in an aspect of the present disclosure, the multiplexer 340 is not disposed at the rear of the first memory 320 as shown in FIG. 3, but rather, as shown in FIG. 4, the multiplexer 340 is placed at the front of the first memory 320.

In other words, referring to FIG. 4, the multiplexer 410 is placed in front of the first memories 321 and 322, and the second memories 351 and 352 are removed, compared to FIG. 3.

Meanwhile, as shown in FIG. 4, when the multiplexer 410 for port swap is placed at the front of the first memories 321 and 322, the multiplexer 410 may be used for not the multiplexer shown in FIG. 3 for data swap but for a multiplexer for memory write enable swap of the first memories 321 and 322. Accordingly, the size of the multiplexer for the memory write enable swap may be reduced compared to that of the multiplexer for the data swap. For example, the multiplexer for the data swap uses a 24-bit 24:1 multiplexer, but the multiplexer for the memory write enable is sufficient for a 1-bit 24:1 multiplexer.

As described above, the multiplexer 410 disposed at the front of the first memories 321 and 322 may transmit a first write enable signal that determines a memory write area in the first memories 321 and 322 based on the memory control signal generated by the memory controller 310 to the first memories 321 and 322.

Additionally, the multiplexer 410 may transmit a second write enable signal that changes the determined memory write area in the first memories 321 and 322 to the first memories 321 and 322 during port swapping.

It is sufficient for the multiplexer 410 to include a plurality of 1-bit multiplexers to transmit the first or second write enable signal to the first memories 321 and 322.

Therefore, the timing controller 140 including the first processor 141 as shown in FIG. 4 may reduce the size of the multiplexer by removing the second memory, which not only reduces the chip size but also reduces power consumption.

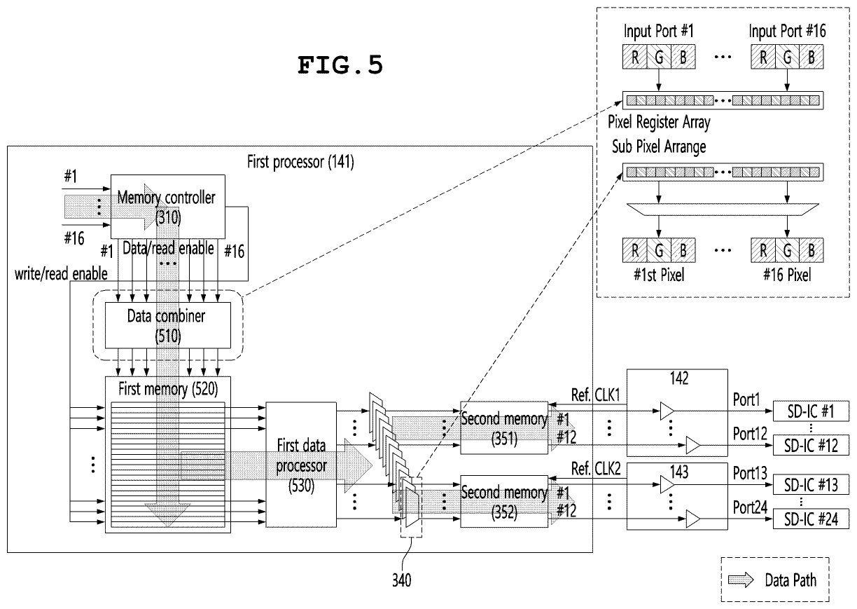

FIG. 5 illustrates a diagram to explain the operation of the timing controller 140 according to another aspect of the present disclosure.

Unlike FIG. 4, FIG. 5 discloses a method of reducing the number of memories by merging data output from multiple input ports.

Basically, the timing controller 140 may require the number of memories equal to the number of input ports x the number of output ports to process pixel data, that is, image data obtained through input ports.

Therefore, in this situation, data throughput is the same than before, but to reduce the overall memory size, for example, a method of merging the data of the input ports and writing to the memory may be used.

On the other hand, if pixel data of the input ports are merged as described above to reduce the memory size, separation of the merged data may be needed. Therefore, the merged data may be rearranged after performing a read operation to memory data, for example, in sub-pixel units, but is not limited thereto.

To this end, referring to FIG. 5, the first processor 141 of the timing controller 140 according to an aspect of the present disclosure may be configured to include a data merger 510.

Referring to FIG. 5, the timing controller 140 according to an aspect of the present disclosure may include a memory controller 310 that receives and transmits image data through an input port and generates a memory control signal, a data merger 510 that receives and merges image data, a first memory 520 that receives the merged image data, a first data processor 530 that maps the merged image data output from the first memory 520, a multiplexer 340 that outputs the mapped data in order, and second memories 351 and 352 that output data output from the multiplexer 340 to be in sync with a second processors 142 and 143 that transmit a differential signal to the source driver 120 through a port.

As shown in FIG. 5, the data merger 510 may receive image data input in parallel through each input port through the memory controller 310 and merge them on a port basis.

At this time, the data merger 510 may be disposed between the memory controller 310 and the first memory 520, for example.

Meanwhile, the data merger 510 may be implemented in the form of a pixel register array, for example, but is not limited thereto.

Meanwhile, as shown in FIG. 5, the first data processor 530 may align the merged data output from the first memory 520 on a subpixel basis.

The first data processor 530 may map the merged pixel data to the structure of the panel 110 and the structure of the source driver 120.

In FIG. 5, the functions of the multiplexer 340 and the second memory 351 and 352 may be, for example, the same as the functions of them as shown in FIG. 3 described above, so duplicate explanations will be omitted.

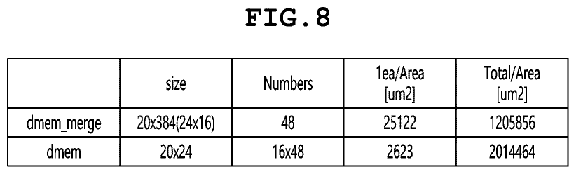

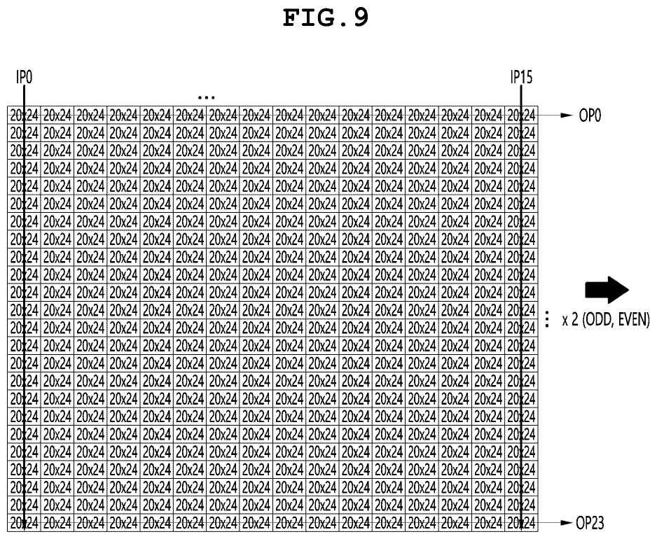

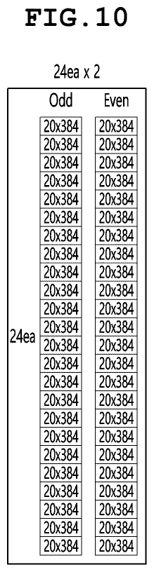

In this way, the timing controller 140 including the first processor 141 shown in FIG. 5 may merge the data of the input ports in advance as shown in FIG. 8, thereby reducing the number of memories shown in FIG. 9 to that of memories in FIG. 10. By reducing the number of memories shown, the memory size compared to data throughput may be reduced by about 40%, which has a technical effect of reducing the chip size and power consumption.

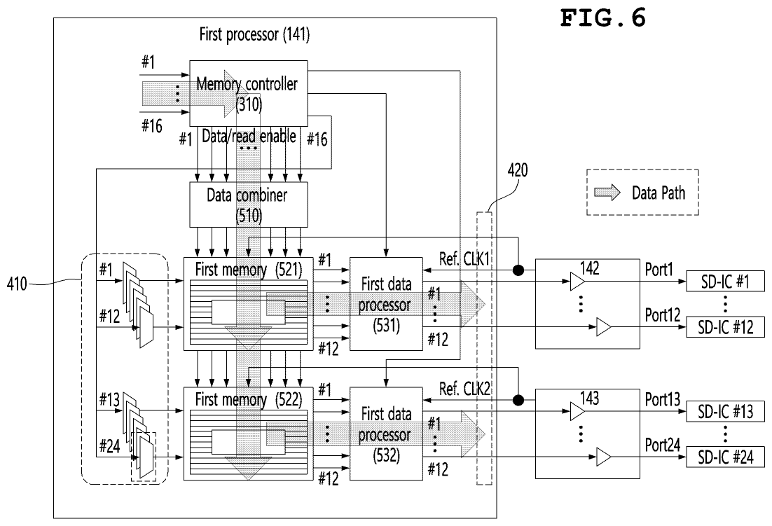

FIG. 6 illustrates a diagram to explain the operation of the timing controller 140 according to another aspect of the present disclosure.

For example, FIG. 6 may be the other aspect of a timing controller 140 which is configured by combining the aspects disclosed in FIGS. 4 and 5. Accordingly, for the description of the configuration of FIG. 6 that overlaps with that of FIGS. 4 and 5, the corresponding portion will be used and the overlapping description will be omitted.

Referring to FIG. 6, the first processor 141 of the timing controller 140 may include, for example, a memory controller 310, a data merger 510, a multiplexer 410, and first memories 521 and 522 and first data processors 531 and 532. At this time, in FIG. 6, the second memory 420 may be unnecessary due to the function of the first memory 521 and 522 according to the change in a position of the multiplexer 410, and be removed.

In FIG. 6, although pixel data input through the input ports may be merged through the data merger 510 as shown in FIG. 5 and transmitted it to the first memories 521 and 522, the multiplexer 410 is connected to the first memory 521 and 522. The multiplexer 410 may be placed in front of the first memory 521 and 522 and output the memory control signal of the memory controller 310. Thus, instead of removing the second memory 420 as shown in FIG. 4, the second memory 420 is configured to synchronize with the second processors 142 and 143.

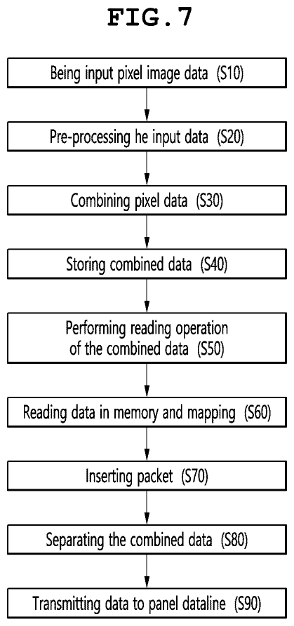

FIG. 7 illustrates a flowchart to explain the operation of the timing controller 140 according to an aspect of the present disclosure.

In S10, the timing controller 140 may receive pixel image data through input ports.

In S20, the timing controller 140 may preprocess the input data.

In S30, the timing controller 140 may merge (e.g., process in parallel) pixel data.

In S40, the timing controller 140 may store the merged data.

At this time, the merged data may be stored in a location to be port swapped with write enabled swap through the multiplexer 410.

In S50, the timing controller 140 may perform a read operation on the merged data.

In S60, the timing controller 140 may perform a read operation on memory data and map the read data.

In S70, the timing controller 140 may insert mapped data into a packet.

In S80, the timing controller 140 may separate the merged data.

Here, a separation of the merged data may represent, for example, converting parallel data into serial data.

In S90, the timing controller 140 may transmit data to data line (DL) in the panel 110 through the second processors 142 and 143 and output the data on the screen through the panel 110.

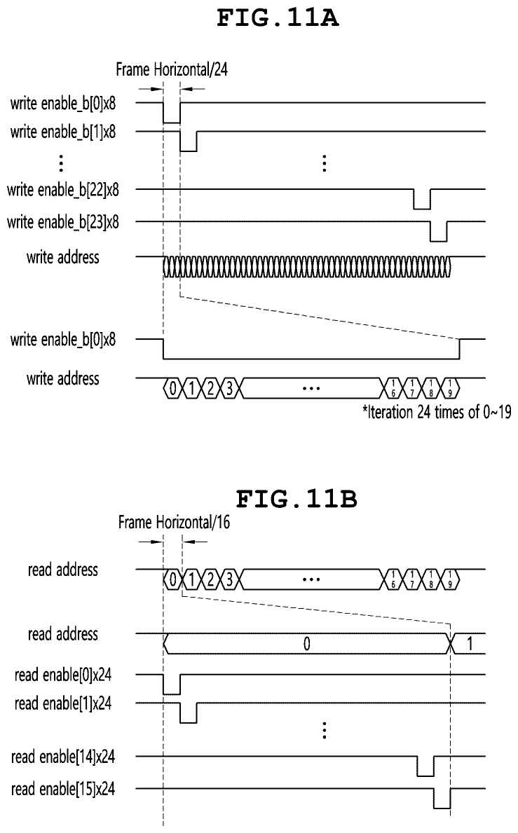

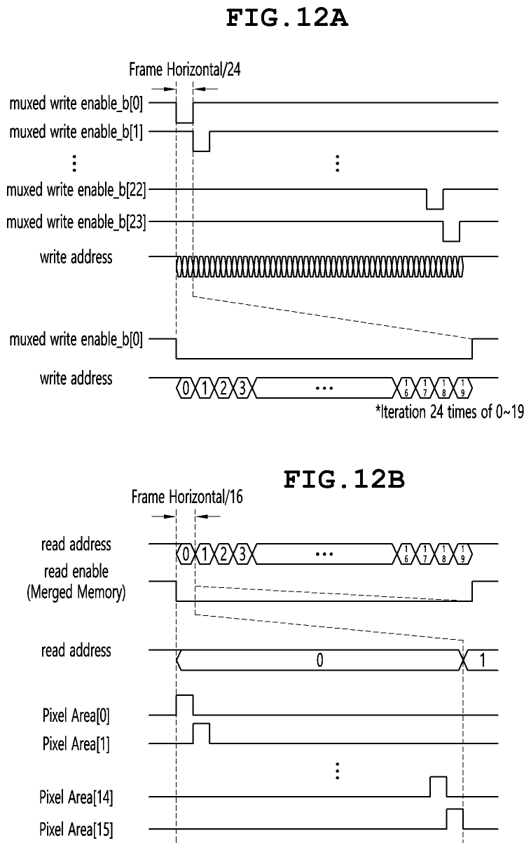

FIGS. 11A-11B and 12A-12B illustrate waveform diagrams of the timing controller 140 related to the present disclosure.

For example, FIGS. 11A-11B illustrate waveforms diagram of the operation of the timing controller 140 disclosed in FIG. 3, and FIGS. 12A-12B illustrate a waveform diagram of the operation of the timing controller 140 disclosed in FIG. 5 or 6.

First, FIG. 11A illustrates a waveform diagram for a write operation to the first memory 320, and FIG. 11B illustrates a waveform diagram for a read operation to the first memory 320.

Referring to FIG. 11A, when the respective 24 write enable signals is transmitted by the memory controller 310, one write address is assigned to each of the 24 write enable signals, and each 0-19 is written at the write address, and 24 write enable signals are input, resulting in the operation being repeated 24 times for each write address.

Referring to FIGS. 11B, 16 read enable signals may be input for each read address by the memory controller 310, so that a memory read operation may be performed. That is, for each read address, a read operation is performed 16 times according to 16 read enable signals, and this is repeated for each read address.

Next, FIG. 12A illustrates a waveform diagram for a write operation for the first memories 321 and 322, and FIG. 12B illustrates a waveform diagram for a read operation for the first memories 321 and 322.

Referring to FIG. 12A, a write address is assigned to perform a write operation by allocating data to the memory of the output ports to be swapped of the 24 multiplexers. At this time, when there is data merging, a data write operation may be performed at once according to the write enable signal.

Referring to FIG. 12B, a read enable signal may be given to all addresses at once, and each address is mapped to a pixel area and arranged in sub-pixel units, so that a read operation may be performed.

In the above, the technical idea of the present disclosure is described along with the accompanying drawings, but this is an illustrative description of an aspect of the present disclosure and does not limit the present disclosure. In addition, it is clear that anyone skilled in the art of the present disclosure may make various modifications and imitations without departing from the scope of the technical idea of the present disclosure.

The present disclosure relates to a device that reduces a chip size and power consumption by efficiently using a memory compared to data throughput to reduce its usage or by reducing the size of memory. Therefore, it is applicable to various devices in which a memory is used, so the present disclosure has an industrial applicability.

1. A timing controller, comprising:
a memory controller configured to receive image data through an input port and generate a memory control signal;
a first memory on which a write/read operation is performed on the image data;
a first data processor configured to perform a read operation on the data in the first memory, map it, and control packets; and
a multiplexer,
wherein the multiplexer is configured to control the first memory to be in sync with a second data processor configured to transmit a differential signal through an output port based on the memory control signal.

2. The timing controller of claim 1, wherein the multiplexer is disposed at a front end of the first memory and is configured to transmit a first write enable signal that determines a memory write area in the first memory to the first memory.

3. The timing controller of claim 2, wherein the multiplexer is configured to transmit a second write enable signal that changes the determined memory write area in the first memory during a port swap to the first memory.

4. The timing controller according to claim 1, wherein the multiplexer is comprised of a plurality of 1-bit multiplexers for transmitting a first write enable signal or a second write enable signal

5. A timing controller, comprising:
a memory controller configured to receive and transmit image data through an input port and generate a memory control signal;
a data merger configured to receive the image data from the memory controller and merge them;
a first memory on which a write/read operation is performed on the merged image data;
a first data processor configured to perform a read operation on the data in the first memory and map it;
a multiplexer configured to output the mapped data in order; and
a second memory configured to output data output from the multiplexer in sync with a second data processor that transmits a differential signal to a source driver through a port.

6. The timing controller according to claim 5, wherein the data merger is configured to merge the image data input in parallel through each input port on a port-by-port basis.

7. The timing controller of claim 6, wherein the first data processor is configured to align the merged image data output from the first memory on a subpixel basis.

8. The timing controller of claim 5, wherein the first memory is used only one memory to write data received through the input port.

9. A timing controller, comprising:
a memory controller configured to receive image data through an input port and generate a memory control signal;
a data merger configured to receive image data from the memory controller and merge them;
a first memory on which a write/read operation is performed on the merged image data;
a first processor configured to perform a read operation on the data in the first memory, map it, and control packets; and
a multiplexer,
wherein the multiplexer is configured to control the first memory to be in sync with a second processor that transmits a differential signal through an output port based on the memory control signal.

10. The timing controller of claim 9, wherein the data merger is configured to merge the image data input in parallel through each input port on a port-by-port basis, and the first processor is configured to align the merged image data output from the first memory on a sub-pixel basis.
